(19) United States
(12) Patent Application Publication
(10) Pub. No.: US 2013/0100915 A1
(43) Pub. Date: Apr. 25, 2013

(54) METHOD OF ALLOCATING RESOURCES TO MOBILE TERMINALS

(71) Applicants: Dinh Thuy Phan Huy, Paris (FR); Helene Averous, Issy Les Moulineaux (FR)

(72) Inventors: Dinh Thuy Phan Huy, Paris (FR); Helene Averous, Issy Les Moulineaux (FR)

(73) Assignee: FRANCE TELECOM, Paris (FR)

(21) Appl. No.: 13/805,917

(22) PCT Filed: Jun. 20, 2011
(86) PCT No.: PCT/FR2011/051412

§ 371 Date: Dec. 20, 2012

(30) Foreign Application Priority Data
Jun. 30, 2010 (FR) 1002743

(51) Int. Cl. H04W 72/04

(52) U.S. Cl. CPC H04W 72/04
USPC 370/329

(57) ABSTRACT

The invention provides a method of allocating resources to mobile terminals. The method comprises the following iterative steps: mobile terminals having at least one elastic link cause the data rates on their elastic links to grow in application of a predetermined temporal law; and when a mobile terminal having at least one constant link detects that its coverage on the constant link is threatened, it sends an alert message to the base station of the cell, with said base station then requiring said mobile terminals that have at least one elastic link to reduce temporarily their data rates on those elastic links by a predetermined quantity. The method is applicable to networks of the W-CDMA type or of the LTE type.

### METHOD OF ALLOCATING RESOURCES TO MOBILE TERMINALS

The invention relates to cellular networks. It is particularly advantageous in networks of the wideband code division multiple access (W-CDMA) type, e.g. the universal mobile telecommunications system (UMTS) or the high speed uplink packet access (HSUPA) network, and also in networks of the long term evolution (LTE) type in their advanced version.

The invention relates more particularly to uplink transmission i.e. from the terminals to the base station, in a cellular network that accommodates radio links having quality of service (QoS) that is constant or elastic (in the context of the present invention such links are referred to as “heterogeneous” links). In this respect, it should be recalled that links with constant QoS, such as “Voice over IP”, or session control signals are links in which the data must be delivered without delay, i.e. with a strong constraint on transit time and at a data rate that is constant, whereas links with elastic QoS, such as the file transfer protocol (FTP) or web navigation are links in which data is delivered without constraint on transit time or on data rate, as a function of the capacities of the network at the moment of transmission. More precisely, a constant QoS link is considered as being “in coverage” if the data is delivered without delay, and “out of coverage” otherwise.

The invention seeks to optimize “cell capacity”, i.e. it has two targets consisting in guaranteeing that all of the constant QoS links are in coverage and that the total data rate (e.g. measured in megabits per second Mbit/s)) of the elastic QoS links is maximized.

In this context, another useful quantity is the “load” of a cell which is conventionally defined using the following formula:

$$load = 1 - \frac{1}{RoT}$$

where the parameter RoT stands for rise over thermal noise and is the ratio of the total power received by the base station (from all sources combined) to the portion of said power that is due solely to thermal noise. When defined in this way, the “load” thus lies in the range 0 to 1.

On the uplink, wireless networks need to cope with interference due to terminals operating in the same frequency band. One way of reducing this type of interference consists in coordinating transmission power among the various terminals. In the context of the present invention, it is assumed that in known manner:
a base station controls the powers at which mobile terminals in its cell transmit in such a manner as to achieve a target total data rate;
the constant links have a constant target data rate; and
the elastic links have a variable data rate, but that cannot exceed a current maximum data rate authorized by the base station.

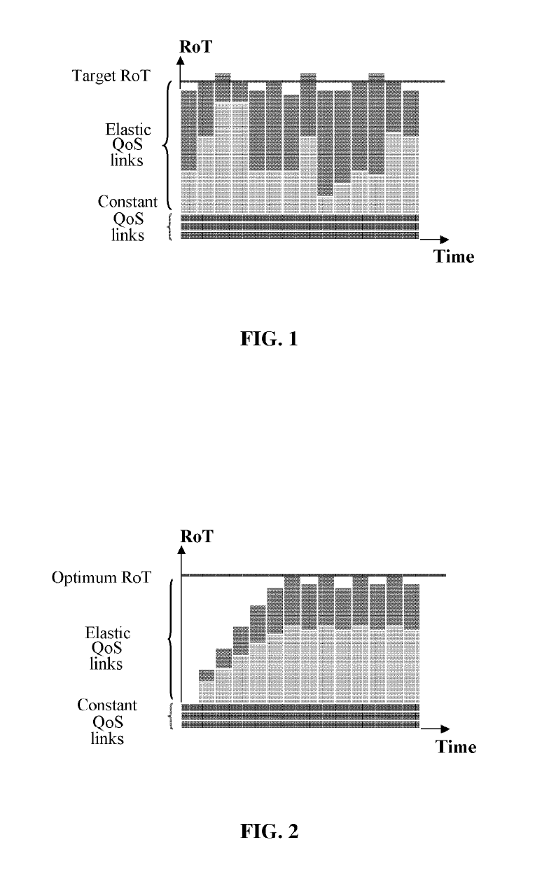

By way of example and with reference to FIG. 1, consideration is given below to the load control mechanism provided in the HSUPA protocol. HSUPA is a third generation (3G) mobile telephony protocol for which the specifications (3GPP TR 25.896, 25.309, and 25.319) have been published by the third generation partnership project (3GPP) in the “release 6” of the UMTS standard. HSUPA is the protocol that is the “reciprocal” of the high speed downlink packet access (HSDPA) protocol; HSUPA offers a theoretical maximum data rate in the uplink direction of 5.76 Mbit/s, while the theoretical maximum data rate on the downlink is 14.4 Mbit/s in HSDPA. These protocols thus make it possible to exchange voluminous multimedia contents with other mobiles or with data-sharing platforms on the Internet.

In HSUPA, one “scheduler” is used per base station. The function of the scheduler is to enable the RoT to reach a value referred to as the “target” RoT that is equivalent to the maximum load that the cell can accept without degrading the constant QoS links. For example, a target RoT of 6 decibels (dB) may be selected in order to guarantee the coverage of the dedicated channel (DCH) links, and of the voice links applying the 3GPP/R99 standard.

As shown diagrammatically in FIG. 1, RoT results from the sum of the contributions due to all of the constant QoS links (three in the figure) plus all of the elastic QoS links (two in the figure). The scheduler uses analytic formulas to estimate and predict the RoT that will be induced by each link and its associated target data rate. More precisely, the scheduler estimates the RoT induced by the constant QoS links; if this RoT is less than the target RoT, then the scheduler calculates the data rate that can be allocated to the elastic QoS links so that the RoT does not exceed the target RoT. Finally, the scheduler sends grants to the terminals using the elastic QoS links in order to update the allocated target data rate; for their elastic QoS links, the terminals then transmit at data rates that are less than or equal to the data rates specified in the grants given by the base station. In contrast, for their constant QoS links, the terminals transmit spontaneously in so-called “non-scheduled transmissions” depending on their requirements, in compliance with the 3GPP TR 25.309 standard entitled “FDD enhanced uplink: overall description; stage 2”.

The above-described scheduling mechanism is based on estimates that are not very reliable, and it presents poor reactivity, such that the actual RoT can on occasion exceed the target value as shown in FIG. 1. When the base station observes such excess RoT it sends a so-called “non-serving relative grant” to a terminal (or to a plurality of terminals) of a neighboring cell asking it (them) to reduce its (their) transmission power, and thus its (their) data rate.

In this context, there arises in particular the question of determining how to select the value for the target RoT. It should be observed that in conventional systems, the target RoT is a radio resource management (RRM) parameter that forms part of the input data to the to the admission control and load control algorithms of each cell.

In practice, when a network is deployed, the target RoT value is usually not optimized: the same target RoT value is selected for all of the base stations and for all types of traffic, e.g. 4.5 dB or 6 dB. This method of setting the target RoT is inexpensive, but also not very effective since it is not adaptive. Under such conditions:
if the target RoT is too small, then the maximum uplink data rate capacity in the cell is limited pointlessly; that applies both to the data rate of the links having a constant QoS and to the data rates of the links having an elastic QoS;
in contrast, if the target RoT is too high, that leads to the cell saturating in the uplink direction, and to interference due to excessive elastic traffic harming the coverage of the constant QoS traffic.

Attempts have therefore been made to optimize the target RoT value for each base station. Thus, the article by J. M. Picard, H. Dubreil, F. Garabedian, and Z. Altman entitled “Dynamic control of UMTS networks by load target turning” (IEEE Veh. Tech. Conf., May 2004) proposes a method of dynamically optimizing the target RoT on the basis of call blocking rate and call dropping rate measurements that are filtered and aggregated over the entire network. That method, based on measurements and statistics concerning quality indicators coming from the base station of interest and from neighboring base stations is a process that is slow, requiring measurements to be acquired in sufficient numbers to be statistically representative of the current quality. Because of its poor reactivity, that method cannot be optimum at all times, since it does not adapt finely to the mixture of types of traffic, of types of mobile station in the cell, and of types of receiver in the base station. Furthermore, that method requires equipment that is complex and expensive.

In addition to the above-mentioned difficulties of determining target RoT, there is an additional drawback involved in using a scheduler, namely that sending “grants” gives rise to a large amount of signaling in the network.

To summarize, this situation is due to the fact that in the prior art there does not exist a method that is simple, adaptive, and inexpensive in terms of resources for optimizing the uplink load of a network that makes heterogeneous links available.

The present invention thus provides a resource allocation method for allocating resources to mobile terminals in a radio cell, the method comprising the following iterative steps:

a) mobile terminals having at least one elastic link cause the data rates on their elastic links to grow in application of a predetermined temporal law; and

b) when a mobile terminal having at least one constant link detects that its coverage on the constant link is threatened, it sends an alert message to the base station of the cell, with said base station then requiring said mobile terminals that have at least one elastic link to reduce temporarily their data rates on those elastic links by a predetermined quantity.

Thus, the invention implements a loop for checking the coverage of the constant links, and a standardized law for expanding the elastic links.

By means of these arrangements, the cell capacity on the uplink is maximized automatically without using RoT control. There is thus in particular no need to determine a target RoT.

It should be observed that in the invention each mobile terminal having at least one constant link acts itself to detect when the coverage of that constant link is threatened, and it then informs the base station. In contrast, in the prior art, each mobile terminal (and indeed regardless of the kinds of link with which it engages the base station) transmits its UE transmission power headroom (UPH) as defined in the 3GPP TS 25.215 standard to the base station; the base station then performs scheduling by means of those UPH values as transmitted by the terminals in order to achieve a target RoT. It should also be observed that in order to constitute the alert messages of the invention as sent by the mobile terminals having at least one constant link, it is possible to use a message size that is much smaller than the size of prior art messages containing a UPH value and sent by all of the mobile terminals.

Thus, advantageously, the method of the invention requires less signaling, and it operates effectively regardless of the type of traffic, of the types of mobile terminals, or of the type of receiver within a base station.

According to particular characteristics, said temporal law applied by a terminal having at least one elastic link is defined by means of indexed data rates, the data rate indices being values taken by a predetermined function La(kT), where k is a time index having integer values and T designates the periodicity with which frames are transmitted, said function growing over an interval

0≦k≦kₘₐₓ

where kₘₐₓ is a predetermined maximum.

By means of these provisions, it is possible to select a faster or slower rate of growth for the elastic data rate of each terminal having an elastic link.

According to other particular characteristics, a mobile terminal having at least one constant link detects that its coverage on that constant link is threatened when:

IC<ICₘᵢₙ

where IC is a coverage indicator measured by the mobile terminal and ICₘᵢₙ is a predetermined minimum value.

By means of these provisions, it is possible to process the constant links with power checking in a closed loop and at a constant data rate.

Correspondingly, the invention also provides various devices.

Firstly, the invention thus provides a mobile terminal. Said mobile terminal is remarkable in that it includes means for:
after an elastic link has been created between said mobile terminal and a base station of a cellular network, receiving from said base station a standardized message concerning data rate growth for said elastic link;
receiving from said base station a saturation message; and
after receiving said saturation message, temporarily reducing the data rate on the elastic link by a predetermined quantity, and then once more causing that data rate to grow.

Secondly, the invention also provides a mobile terminal. Said mobile terminal is remarkable in that it includes means for:
detecting that its coverage on a constant link that it maintains with a base station of a cellular network is threatened; and
after said detection, sending an alert message to said base station.

According to particular characteristics, said mobile terminal detects that its coverage on the constant link is threatened when:

IC<ICₘᵢₙ

where IC is a coverage indicator measured by the mobile terminal and ICₘᵢₙ is a predetermined minimum.

Thirdly, the invention also provides a base station of a cellular network. Said base station is remarkable in that it includes means for:
after an elastic link has been created between itself and a mobile terminal, sending a standardized message to said mobile terminal concerning data rate growth for said elastic link;
receiving a loss of coverage message from a terminal having at least one constant link; and
after receiving said loss of coverage message, sending a saturation message to all the mobile terminals having at least one elastic link.

The advantages provided by these devices are essentially the same as those provided by the corresponding methods briefly outlined above.

It should be observed that it is possible to implement the devices that are briefly described above in the context of software instructions and/or in the context of electronic circuits.

The invention also provides a computer program downloadable from a communications network and/or stored on a computer-readable medium and/or executable by a microprocessor. The computer is remarkable in that it includes instructions for executing steps of any of the resource allocation methods described briefly above, when executed on a computer.

The advantages provided by the computer program are essentially the same as those provided by said methods.

Other aspects and advantages of the invention appear on reading the following detailed description of particular implementations given as non-limiting examples. The description refers to the accompanying drawing, in which:

FIG. 1 is a diagrammatic graph showing variation in the RoT parameter as a function of time in prior art systems; and

FIG. 2 is a diagrammatic graph showing variation in the RoT parameter as a function of time in a system of the invention.

The system of the invention comprises a given base station and mobile terminals attached to the base station via links of constant or elastic QoS. It should be observed that a single terminal may possibly establish a plurality of links simultaneously, potentially heterogeneous links.

An implementation of the invention is described below.

During a system configuration stage, the base station and the terminals record the following elements:
the definition of a coverage indicator IC that is to be calculated by each terminal capable of establishing a constant link;
a sequence of packet sizes, or in equivalent manner, a sequence of standardized data rates (such as the “E-TFC” table in the HSUPA standard, see for example http://www.3gpp.org/ftp/Specs/archive/25 series/25.321/25 321-7h0.zip, Appendix B, page 134), ordered in increasing manner and indexed from j=1 to j=Nₘₐₓ where the index Nₘₐₓ corresponds to a predetermined maximum elastic link data rate for the terminal in question;
a time index k having integer values, with 0≦k≦kₘₐₓ, where kₘₐₓ is a predetermined integer; and
a temporal law defined by means of a predetermined function La(kT), where T designates the frame transmission periodicity, said function increasing over the interval 0≦k≦kₘₐₓ, and being capable of having the value zero or positive integer values (but preferably not being capable of exceeding Nₘₐₓ since the terminal in question would then be physically incapable of transmitting at such a high data rate).

It is assumed, in conventional manner, that each terminal capable of setting up a constant link is capable of measuring the path loss PL of the signals it exchanges with the base station to which it is attached. It should be recalled that path loss is the reduction in the power density of an electromagnetic wave during its propagation; this reduction may be due to numerous causes, such as expansion in three-dimensional space, refraction, diffraction, reflection, absorption, the characteristics of the surroundings, or the height of the antennas.

Concerning the coverage indicator IC, in a first variant it may be taken to be equal to the ratio of the available power; it is calculated by the terminal, e.g. using the following formula:

$$IC = \frac{{Ptx}_{max}}{Ptx}$$

where Ptx designates the current transmission power of the mobile terminal and Ptxₘₐₓ the maximum transmission power of the terminal. The coverage indicator IC thus serves as an indicator of the power reserve available to the terminal, and it makes it possible to guarantee the coverage of the terminals that are actually present and in the process of transmitting within the cell.

In a second variant, consideration is given to another way of selecting the coverage indicator IC for the purpose of guaranteeing the coverage of mobile terminals that might enter the cell in question at a subsequent time. Under such circumstances, a mobile terminal that is actually present and transmitting within the cell, with path loss of PL, will take account of the ratio of the available power for a potential user having a target path loss at the border of the cell of PL_{bord}; it then calculates IC using the following formula:

$$IC = \frac{{Ptx}_{max}}{Ptx} \times \frac{PL}{{PL}_{bord}}$$

Concerning the function La(kT), it is possible to use for example;
La(kT)=E[αkT+β] (linear growth); or
La(kT)=E[α log(kT)+β] (logarithmic growth; or indeed
La(kT)=E[exp(αkT+β)] (exponential growth); where E[ . . . ] designates the “integer portion” function. It should be observed that the function La(kT) may be selected differently from one terminal to another (including a different selection for the value of kₘₐₓ); under such circumstances, the trigger message (see below) received from the base station may inform the terminal which function it is to apply.

Thus, each terminal takes into account for each elastic link set up by the terminal;
a current time index k that is initialized at 0 on creation of this elastic link; and
the index j of the current data rate authorized for this elastic link, with j=La(kT).

In the present implementation of the invention, the following steps are applied to the mobile terminals served by a given base station.

During a so-called “trigger” step E1 that takes place after an elastic link has been created between a mobile terminal Mₑ and the base station, the base station sends a standardized message to the terminal Mₑ concerning the rate of data rate growth for the elastic link. When the terminal Mₑ receives the message, it initializes its time index k to 0, and its data rate index j to La(kT).

During a so-called “growth” step E2, the terminal Mₑ performs the following updates each time it transmits a new frame:
k=min (k+1,kₘₐₓ); and
j=La(kT).

During a “constant link coverage check” step E3, if a mobile terminal M_{f} having a constant link finds that:

IC<ICₘᵢₙ

where ICₘᵢₙ is a predetermined minimum for the coverage indicator, that terminal M_{f} sends a loss of coverage message to the base station.
During a “constant link coverage protection” step E4:
on receiving a loss of coverage message from a mobile terminal M_{f}, the base station sends a saturation message (at least) to all of terminals having at least one elastic link; and
on receiving this saturation message, the terminals having at least one elastic link decrease the current value of their time indices k by a predetermined quantity Δk (or taking the value k=0 if the current value of k is less than Δk); these terminals then restart the growth process (step E2) from the new time index value k.

Thus, the invention uses the coverage indicators IC of those terminals that have at least one constant link; these indicators are representative of real specific conditions within the cell (types of terminal, types of traffic, propagation environment, and so on). As shown diagrammatically in FIG. 2, implementing the invention has the result of automatically obtaining an optimum RoT, and thus an optimum uplink data rate in the cell. The mechanism of the invention for covering the constant links (steps E3 and E4 in the embodiment described above) avoids any risk of the network saturating because of its high level of reactivity.

Other implementations of the present invention may be envisaged. For example, above steps E1 and E2 may be replaced by a conventional scheduler, providing it ensures that the load of the cell is increased progressively.

The implementation of the invention within nodes of the telecommunications network (more precisely the base stations and the mobile terminals) may be performed by means of software and/or hardware components.

The software components may be incorporated in a conventional computer program for managing a network node. That is why, as mentioned above, the present invention also provides a computer system. The computer system comprises in conventional manner a central processor unit using signals to control a memory, and an input unit and an output unit. Furthermore, the computer system may be used to execute a computer program including instructions for implementing the resource allocation method of the invention.

The invention also provides a computer program that is downloadable from a communications network, the program including instructions for executing steps of a resource allocation method of the invention when it is executed by a computer. The computer program may be stored on a computer-readable medium and may be executable by a microprocessor.

The program may make use of any programming language, and it may be presented as source code, object code, or code intermediate between source code and object code, in a partially compiled form, or in any other desirable form.

The invention also provides a computer-readable data medium including instructions of a computer program as mentioned above.

The data medium may be any entity or device capable of storing the program. For example, the medium may comprise storage means such as a read only memory (ROM), e.g. a compact disk (CD) ROM or a microelectronic circuit ROM, or indeed magnetic recording means, e.g. a universal serial bus (USB) flash drive or a hard disk.

Furthermore, the data medium may be a transmissible medium such as an electrical or optical signal, suitable for being conveyed by an electrical or optical cable, by radio, or by other means. The computer program of the invention may in particular be downloaded from an Internet type network.

In a variant, the data medium may be an integrated circuit in which the program is incorporated, the circuit being adapted to execute or to be in the execution of the resource allocation method of the invention.

1. A resource allocation method for allocating resources to mobile terminals in a radio cell, the method comprising:
mobile terminals (Mₑ) having at least one elastic link cause the data rates on their elastic links to grow in application of a predetermined temporal law; and
when a mobile terminal (M_{f}) having at least one constant link detects that its coverage on the constant link is threatened, it sends an alert message to the base station of the cell, with the base station then requiring the mobile terminals (Mₑ) that have at least one elastic link to reduce temporarily their data rates on those elastic links by a predetermined quantity.

2. The resource allocation method according to claim 1, wherein the temporal law applied by a terminal (Mₑ) having at least one elastic link is defined by indexed data rates, the data rate indices being values taken by a predetermined function La(kT), where k is a time index having integer values and T designates the periodicity with which frames are transmitted, theses function growing over an interval
0≦k≦kₘₐₓ
where kₘₐₓ is a predetermined maximum.

3. The resource allocation method according to claim 1, wherein a mobile terminal (M_{f}) having at least one constant link detects that its coverage on that constant link is threatened when:
IC<ICₘᵢₙ
where IC is a coverage indicator measured by the mobile terminal (M_{f}) and ICₘᵢₙ is a predetermined minimum value.

4. The resource allocation method according to claim 3, wherein the coverage indicator is calculated using the formula:
$$IC = \frac{{Ptx}_{max}}{Ptx}$$
where Ptx designates the current transmission power of the mobile terminal (M_{f}) and Ptxₘₐₓ its maximum transmission power.

5. The resource allocation method according to claim 3, wherein the coverage indicator is calculated using the formula:
$$IC = \frac{{Ptx}_{max}}{Ptx} \times \frac{PL}{{PL}_{bord}}$$
where Ptx designates the current transmission power of the mobile terminal (M_{f}), Ptxₘₐₓ its maximum transmission power, PL its path loss, and PL_{bord} a target path loss at the borders of the cell.

6. A mobile terminal (Mₑ) configured to:
after an elastic link has been created between the mobile terminal (Mₑ) and a base station of a cellular network, receive from the base station a standardized message concerning data rate growth for theses elastic link;
receive from the base station a saturation message; and
after receiving the saturation message, temporarily reduce the data rate on the elastic link by a predetermined quantity, and then once more cause the data rate to grow.

7. A mobile terminal (M_{f}) configured to:
detect that its coverage on a constant link that it maintains with a base station of a cellular network is threatened; and
after detection, send an alert message to the base station.

8. The mobile terminal according to claim 7, wherein the mobile terminal detects that its coverage on the constant link is threatened when:
IC<ICₘᵢₙ
where IC is a coverage indicator measured by the mobile terminal (M_{f}) and ICₘᵢₙ is a predetermined minimum.

9. The mobile terminal according to claim 8, wherein the coverage indicator is calculated using the formula:
$$IC = \frac{{Ptx}_{max}}{Ptx}$$
where Ptx designates the current transmission power of the mobile terminal (M_{f}) and Ptxₘₐₓ its maximum transmission power.

10. The mobile terminal according to claim 8, wherein the coverage indicator is calculated using the formula:
$$IC = \frac{{Ptx}_{max}}{Ptx} \times \frac{PL}{{PL}_{bord}}$$
where Ptx designates the current transmission power of the mobile terminal (M_{f}), Ptxₘₐₓ its maximum transmission power, PL its path loss, and PL_{bord} a target path loss at the borders of the cell.

11. A base station of a cellular network, the base station being configured to:
after an elastic link has been created between itself and a mobile terminal (Mₑ), send a standardized message to the mobile terminal (Mₑ) concerning data rate growth for the elastic link;
receive a loss of coverage message from a terminal (M_{f}) having at least one constant link; and
after receiving the loss of coverage message, send a saturation message to all the mobile terminals having at least one elastic link.

12. A non-transitory computer-readable medium including computer program code instructions that, when executed by a computer, are programmed to execute the method according to claim 1.

13. (canceled)
